(19) United States
(12) Patent Application Publication
(10) Pub. No.: US 2011/0255561 A1
(43) Pub. Date: Oct. 20, 2011

(54) APPARATUS CONFIGURED TO PROVIDE A WAVELENGTH-SWEPT ELECTRO-MAGNETIC RADIATION

(75) Inventors: Brian Goldberg, Cambridge, MA (US); Guillermo J. Tearney, Cambridge, MA (US); Brett Eugene Bouma, Quincy, MA (US); Reza Motgahian-Nezam, Glendale, CA (US)

(73) Assignee: The General Hospital Corporation, Boston, MA (US)

(21) Appl. No.: 13/003,983

(22) PCT Filed: Jul. 14, 2009
(86) PCT No.: PCT/US09/50563

§ 371 Date: Jul. 5, 2011

Related U.S. Application Data
(60) Provisional application No. 61/080,580, filed on Jul. 14, 2008.

(51) Int. Cl. H01S 3/10

(52) U.S. Cl. 372/20

(57) ABSTRACT

Exemplary embodiments of apparatus according to the present disclosure are provided. For example, an apparatus for providing electromagnetic radiation to a structure can be provided. In one exemplary embodiment, the apparatus can provide at least one electromagnetic radiation, and include at least one first arrangement which can be configured to generate the electromagnetic radiation(s) having at least one wavelength that varies over time. The exemplary apparatus can also include at least one second arrangement which can be configured to power the first arrangement(s) independently from an external power source. In another exemplary embodiment the apparatus can include at least one particular arrangement which is configured to generate the electromagnetic radiation(s) having at least one wavelength that varies over time. The particular arrangement(s) can include a resonant cavity that has a roundtrip optical transit time of approximately less than 0.7 nsec.

### CROSS-REFERENCE TO RELATED APPLICATION(S)

This application relates to and claims the benefit of priority from U.S. patent application Ser. No. 61/080,580, filed on Jul. 14, 2008, the entire disclosure of which is incorporated herein by reference.

### FIELD OF THE DISCLOSURE

The present disclosure relates to optical systems, and more particularly to apparatus configured to provide a wavelength-swept electro-magnetic radiation and a compact laser providing wavelength-swept emission.

### BACKGROUND INFORMATION

Considerable effort has been devoted to develop rapidly and widely tunable wavelength laser sources for optical reflectometry, biomedical imaging, sensor interrogation, and tests and measurements. A narrow line-width, wide-range and rapid tuning have been realized by use of an intracavity narrowband wavelength scanning filter. For example, mode-hopping-free single-frequency operation has been demonstrated in an extended-cavity semiconductor laser by using an elaborate grating filter design. However, the tuning speed demonstrated so far using this approach has been limited less than 100 nm/s. In many applications such as biomedical imaging, an instantaneous linewidth of 10 GHz is sufficiently narrow since it provides a ranging depth of a few millimeters in tissues in optical coherence tomography and a micrometer-level transverse resolution in spectrally-encoded confocal microscopy. The linewidth of an order of 10 GHz can be achievable by using an intracavity tuning element such as an acousto-optic filter, Fabry-Perot filter, and galvanometer-driven grating filter. By incorporating a rotating polygon beam scanner, intracavity wavelength tuning has been demonstrated at repetition rates exceeding 100 kHz.

As the repetition rate is increased, however, the overlap of the spectrum of the circulating light within the laser resonator and the instantaneous spectrum of the tuning element decreases, resulting in reduced emission power and reduced temporal coherence of the emitted light. By increasing the resonator length to several km, the delay time for one round-trip transit of the laser resonator can be reduced and synchronized with the repetitive operation of the scanning filter, thereby maintaining a close overlap of the spectrum of the circulating light within the laser resonator and the instantaneous spectrum of the tuning element.

This approach, however, may require long lengths of optical fiber that are prone to thermally dependent and temporally changing birefringence. Additionally, this approach can require a synchronization of the optical resonator round trip time with the repetition rate of the optical filter.

It has previously been demonstrated that a laser having the above characteristics can be applied for optical frequency-domain ranging and optical frequency-domain imaging, the latter being an extension from an analogous technology, optical coherence tomography.

Point-of-care optical frequency domain imaging (OFDI) systems, such as those for use in needle guidance, prefer to use miniature wavelength-swept lasers. Point-of-care (POC) technologies aim to bring advances in medical technology directly to the patient. A successful POC technology should be small, inexpensive, lightweight, accurate, robust, and easy to use. POC testing, imaging and diagnostics are becoming more and more common within many medical settings including primary, home, and emergency care. (See C. P. Price and L. J. Kricka, “Improving Healthcare Accessibility through Point-of-Care Technologies,” Clinical Chemistry 53, 1665-1675 (2007)).

Imaging technologies have the potential to be beneficial within the field of new POC technologies, facilitating the physician to see deeper, with higher resolution, and with greater contrast than with the naked eye. At the point of care, imaging can provide crucial diagnostic information (see Y. Beaulieu, “Bedside echocardiography in the assessment of the critically ill,” Crit Care Med 35, S235-S249 (2007)), guide procedures (see S. Gupta and D. Madoff, “Image-guided percutaneous needle biopsy in cancer diagnosis and stagin,” Tech Vasc Interv Radiol 10, 88-101 (2007); and B. D. Goldberg, N. V. Iftimia, J. E. Bressner, M. B. Pitman, E. Halpern, B. E. Bouma, and G. J. Tearney, “An automated algorithm for differentiation of human breast tissue using low coherence interferometry for fine needle aspiration breast biopsy.,” Journal of Biomedical Optics 13, 014014 (2008)), and identify tumor margins during surgical biopsies (see A. M. Zysk and S. A. Boppart, “Computational methods for analysis of human breast tumor tissue in optical coherence tomography images,” Journal of Biomedical Optics 11(2006)). In other settings, new imaging technologies are performing comprehensive screening in ways that may eliminate the need for biopsies altogether. (See M. J. Suter, B. J. Vakoc, N. S. Nishioka, P. S. Yachimski, M. Shishkov, R. Motaghiannezam, B. E. Bouma, and G. J. Tearney, “In Vivo 3D Comprehensive Microscopy of the Human Distal Esophagus,” Gastrointestinal Endoscopy 65, AB154-905 (2007); B. J. Vakoc, M. Shishko, S. H. Yun, W.-Y. Oh, M. J. Suter, A. E. Desjardins, J. A. Evans, N. S. Nishioka, G. J. Tearney, and B. E. Bouma, “Comprehensive esophageal microscopy by using optical frequency-domain imaging (with video),” Gastrointestinal Endoscopy 65, 898-905 (2007); and J. A. Evans, J. M. Poneros, B. E. Bouma, J. Bressner, E. F. Halpern, M. Shishkov, G. Y. Lauwers, M. Mino-Kenudson, N. S. Nishioka, and G. J. Tearney, “Optical Coherence Tomography to Identify Intramucosal Carcinoma and High-Grade Dysplasia in Barrett's Esophagus,” Clinical Gastroenterology and Hepatology 4, 38-43 (2006)).

Optical frequency domain imaging (OFDI) is a high-resolution (e.g., ˜10 μm), cross-sectional, fiber-optic imaging method and/or procedure that facilitate a measurement of tissue microstructure, birefringence (correlated to collagen that may be found in blood vessel adventitia), blood flow (Doppler), and absorption. (See S. H. Yun, C. Boudoux, G. J. Tearney, and B. E. Bouma, “High-speed wavelength-swept semiconductor laser with a polygon-scanner-based wavelength filter,” Optics letters 28, 1981-1983 (2003); and M. A. Choma, K. Hsu, and J. A. Izatt, “Swept source optical coherence tomography using an all-fiber 1300-nm ring laser source,” Journal of biomedical optics 10, 44009 (2005)). OFDI systems can generally comprise three exemplary elements; a) a rapidly swept laser, b) a fiber-based interferometer, and c) detection and processing electronics. A portable OFDI system can preferably utilize miniature components for all three elements.

Accordingly, there may be a need to address and/or overcome at least some of the deficiencies described herein above.

### SUMMARY OF EXEMPLARY EMBODIMENT(S)

To overcome at least some of such deficiencies, exemplary embodiments of an apparatus configured to provide a wavelength-swept electro-magnetic radiation and a compact laser providing wavelength-swept emission can be provided, e.g., a miniature wavelength-swept laser.

Exemplary embodiments of the present disclosure describe a laser source or apparatus which can be miniaturize, and that can produce a wavelength-swept optical emission. For example, the source can emit a narrowband spectrum with its center wavelength being swept over a broad wavelength range at a high repetition rate.

For example, certain exemplary embodiments of the present disclosure relate to a laser resonator whose dimensions can be reduced so that the round trip transit time of light within the resonator is brief relative to the scanning rate of the optical filter. The exemplary embodiments of the present disclosure can facilitate a generation of a wavelength-swept emission at high repetition rates without reducing emitted power or temporal coherence.

In one particular exemplary embodiment of the present disclosure, the laser resonator length can correspond to a round-trip optical transit time of less than about 0.7 ns and the laser emits more than about 10 mW of average power, while the wavelength can be repetitively swept over a wavelength range of more than 80 nm. The instantaneous line-width of the laser can be made to fall between about 0.05 nm and 0.3 nm, an exemplary range that can be beneficial for interferometric ranging and biomedical imaging procedures; a more narrow line-width can result in increased background noise through coherent interference and a broader line-width can result in a decreased coherence length. The repetition rate of the exemplary embodiment can be higher than about 15 kHz, an exemplary rate that can be suitable for rapidly acquiring structural and compositional information describing a sample.

According to a further exemplary embodiment of the present disclosure, a laser source can be provided which can be based on a tunable optical filter using a reflection grating and a miniature resonant scanning mirror. The exemplary laser source can have a 100 nm bandwidth centered at about 1310 nm, approximately 0.15 nm instantaneous line width, and either about 1 or 16 kHz repetition rates with approximately 10 mW output power. The entire exemplary laser source system can be roughly the size of a deck of cards as shown in FIG. 1(b), and can be fully battery powered using commercially available laser and temperature controllers.

In one exemplary embodiment of the present disclosure, an apparatus for providing electromagnetic radiation to a structure can be provided. In such exemplary embodiment, the apparatus can provide at least one electromagnetic radiation, and include at least one first arrangement which can be configured to generate the electromagnetic radiation(s) having at least one wavelength that varies over time. The exemplary apparatus can also include at least one second arrangement which can be configured to power the first arrangement(s) independently from an external power source.

For example, such second arrangement(s) can be self contained with respect to providing power to the first arrangement(s). The wavelength(s) can vary over a range that is approximately greater than 80 nm. At one particular point in time, the electromagnetic radiation(s) can have a spectral width of approximately between 0.05 nm and 0.3 nm. A variation of the wavelength(s) can be repetitive over a characteristic frequency of approximately greater than 15 kHz. The first arrangement(s) can include a resonant cavity that has a roundtrip optical transit time of approximately less than 0.7 nsec. Further, the wavelength(s) can vary at a rate of approximately greater than 100 THz per millisecond.

In another exemplary embodiment the apparatus can include at least one particular arrangement which is configured to generate the electromagnetic radiation(s) having at least one wavelength that varies over time. The particular arrangement(s) can include a resonant cavity that has a roundtrip optical transit time of approximately less than 0.7 nsec.

For example, the wavelength(s) can vary over a range that is approximately greater than 80 nm. At one particular point in time, the electromagnetic radiation(s) can have a spectral width of approximately between 0.05 nm and 0.3 nm. A variation of the wavelength(s) can be repetitive over a characteristic frequency of approximately greater than 15 kHz. The wavelength(s) can also vary over a range that is approximately greater than 80 nm. The exemplary apparatus can also include at least one further arrangement which can be configured to power the particular arrangement(s) independently from an external power source. Further, the wavelength(s) can vary at a rate of approximately greater than 100 THz per millisecond.

These and other objects, features and advantages of the exemplary embodiment of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present invention will become apparent from the following detailed description taken in conjunction with the accompanying figures showing illustrative embodiments of the present disclosure, in which:

FIG. 1(a) is a block diagram of an exemplary embodiment of a wavelength-swept source (e.g., laser) which can be relative small or miniaturized according to the present invention;

FIG. 1(b) is an exemplary photograph of the exemplary embodiment of the wavelength-swept source shown in FIG. 1(a);

FIG. 2 is a graph of exemplary emission characteristics of the miniature wavelength-swept laser according to the present disclosure; and

FIG. 3 is a graph of an exemplary signal roll-off as a function of depth in the forward sweep direction according to the present disclosure; and

FIG. 4 is a graph of an exemplary signal roll-off as a function of depth in the backward sweep direction according to the present disclosure; and

FIG. 5 is a graph of an exemplary axial point-spread function in the forward and backward sweep directions according to the present disclosure; and

FIG. 6 is a graph of an exemplary output power stability trace of the miniature wavelength-swept laser according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described exemplary embodiments without departing from the true scope and spirit of the subject disclosure as defined by the appended claims.

### DETAILED DESCRIPTION OF EXEMPLARY EMBODIMENTS

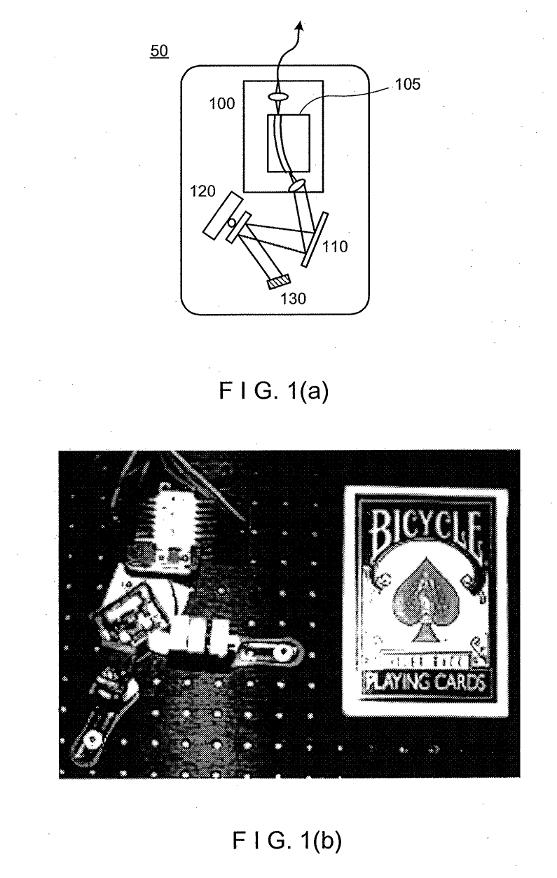

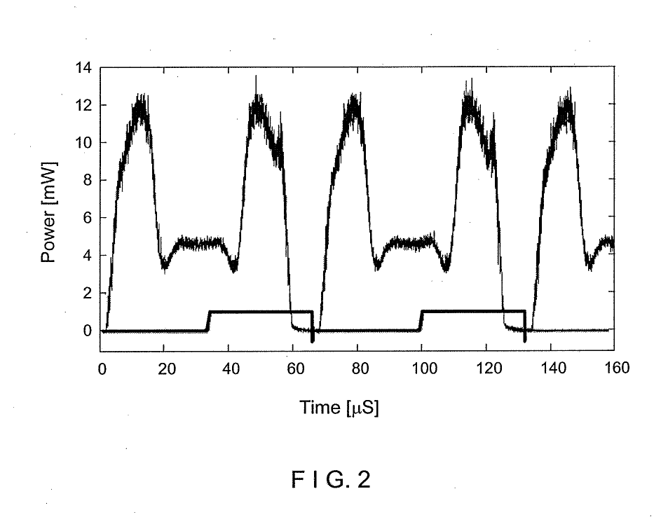

An exemplary embodiment of a laser arrangement 50 according to the present disclosure is shown in FIG. 1(s). For example, the exemplary laser arrangement 50 illustrated in FIG. 1(a) can be based on, e.g., a tunable optical filter using a reflection grating 110 and a miniature resonant scanning mirror 120. The gain arrangement 100 (which includes a gain element 105) of the laser arrangement 50 can be or include a semiconductor optical amplifier, in which the waveguide can be terminated at one end by a normal-incidence facet, forming an output coupler, and at the second end by an angled facet, which delivers light to an external cavity. Wavelength selection is accomplished using an 1200 l/mm diffraction grating, oriented to an angle of incidence of approximately 80 degrees, followed by the resonant scanning galvanometer mirror 120 and a fixed mirror 130. As the resonant mirror 120 can rotate, the output wavelength of the laser arrangement can be swept in time. The fixed mirror 130 can facilitate the laser arrangement to operate in the so-called “2X configuration”, which can provide a broader tuning bandwidth and an improved axial resolution.

The exemplary resonant mirror 120 can be driven with a high Q resonant electric drive circuit that can utilize a very low electrical power. For example, the resonant mirror 120 can be operated for long periods of time with a 9V battery. In addition, the laser arrangement (e.g., the source) can be driven with commercially available miniature laser and temperature controllers and powered by, e.g., 3V lithium batteries. The entire exemplary laser arrangement, including optics and electronics, can be configured with a form factor that can be approximately the size of a deck of cards, as shown in FIG. 1(b).

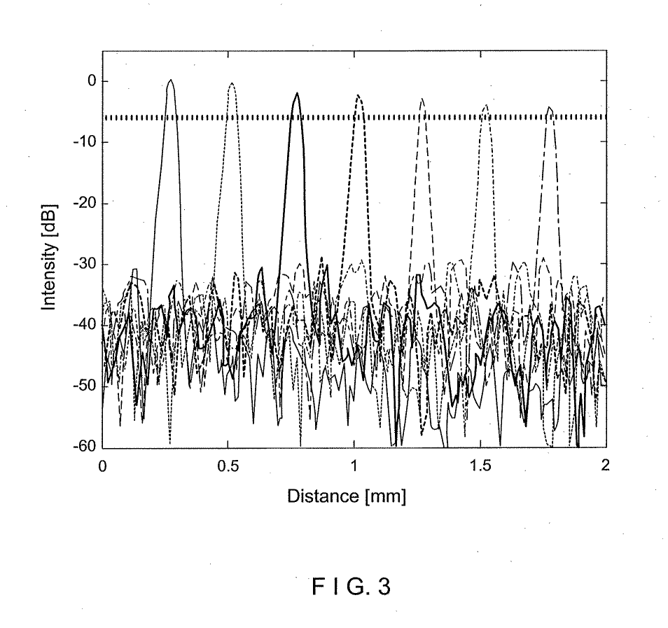

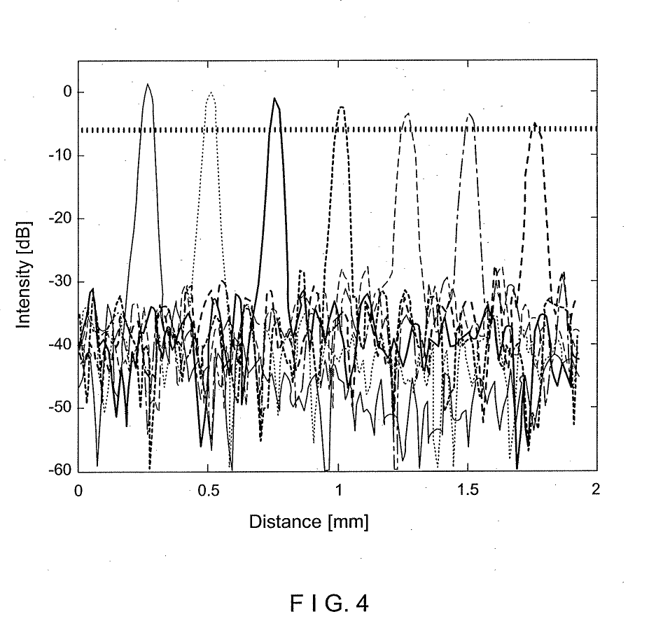

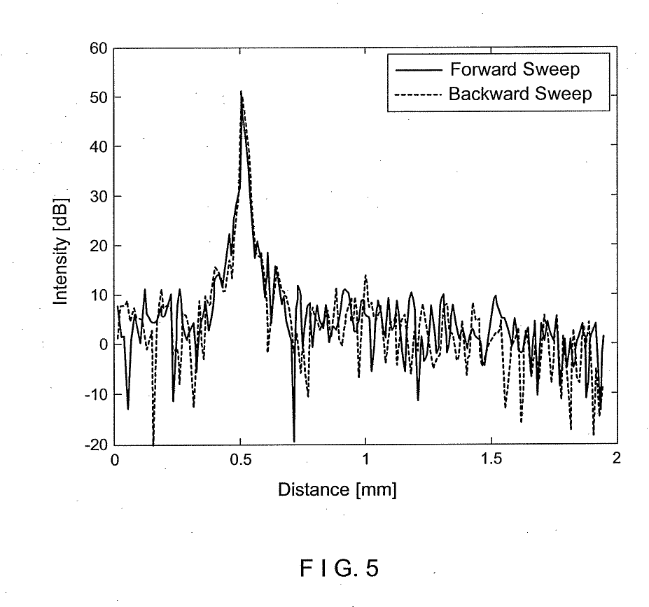

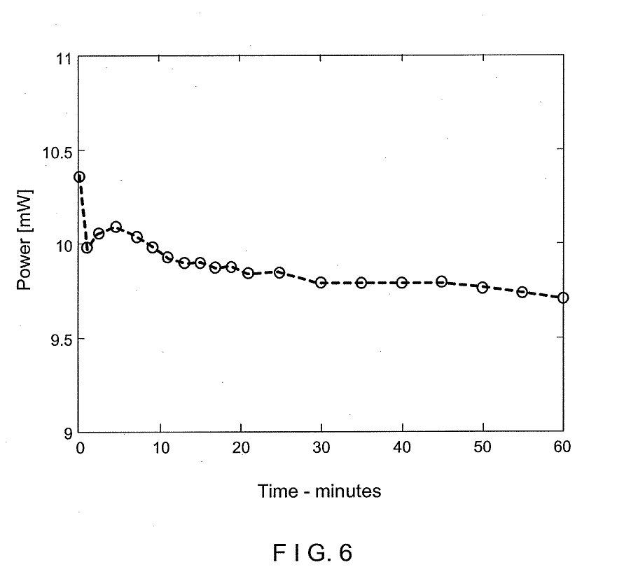

An exemplary embodiment of the laser arrangement 50 can produce a tuning range of about 75 nm centered at about 1340 nm and an instantaneous line-width of about 0.24 nm. These exemplary specifications can correspond to an OFDI axial resolution of about 8 μm and a coherence length of greater than about 3.5 mm (as shown in FIGS. 3 and 4)). The bidirectional wavelength sweep pattern of the laser (e.g., at a duty cycle of about 87.6%) can produce an average output power of about 6 mW while operating the resonant scanner at either about 1 kHz or 15.3 kHz. A graph of an exemplary axial point-spread function in the forward and backward sweep directions according to an exemplary embodiment of the present disclosure is shown in FIG. 5. In addition, an exemplary graph of an output power stability trace of the miniature wavelength-swept laser according to an exemplary embodiment of the present disclosure is shown in FIG. 6.

Driving the resonant mirror 120 with a high Q resonant electric drive circuit can result in a very low power consumption. For example, the mirror can be driven for more than about 1 hour with a single 9V battery. In addition, an exemplary semiconductor source can be operated with commercially available miniature laser and temperature controllers and powered by 3V lithium batteries. For example, the battery-powered configuration has been tested for over an hour with only minimal drop in output power. This exemplary operating duration can be sufficient for point-of-care deployment in which about 10-15 minute operation can be anticipated, followed by recharging time between applications.

According to another exemplary embodiment of the present disclosure, the laser arrangement 50 can be a 1 kHz system. Such exemplary system can provide, e.g., about 10 mW average power, 65% duty cycle, 97.5 nm Tuning range, ranging depth greater than 2 mm. The exemplary grating 110 of this system can be about 830 l/mm. In another exemplary embodiment of the present disclosure, the laser arrangement 50 can be a 15.3 kHz system. Such exemplary system can provide, e.g., about 6.0 mW average power, approximately 85.7% duty cycle, 75 nm tuning range, with an exemplary ranging depth greater than about 1.75 mm. The exemplary grating 110 of this system can be about 1200 l/mm.

The foregoing merely illustrates the principles of the invention. Various modifications and alterations to the described embodiments will be apparent to those skilled in the art in view of the teachings herein. Indeed, the arrangements, systems and methods according to the exemplary embodiments of the present invention can be used with and/or implement any OCT system, OFDI system, SD-OCT system or other imaging systems, and for example with those described in International Patent Application PCT/US2004/029148, filed Sep. 8, 2004 which published as International Patent Publication No. WO 2005/047813 on May 26, 2005, U.S. patent application Ser. No. 11/266,779, filed Nov. 2, 2005 which published as U.S. Patent Publication No. 2006/0093276 on May 4, 2006, and U.S. patent application Ser. No. 10/501,276, filed Jul. 9, 2004 which published as U.S. Patent Publication No. 20050018201 on Jan. 27, 2005, the disclosures of which are incorporated by reference herein in their entireties. It will thus be appreciated that those skilled in the art will be able to devise numerous systems, arrangements and methods which, although not explicitly shown or described herein, embody the principles of the invention and are thus within the spirit and scope of the present invention. In addition, to the extent that the prior art knowledge has not been explicitly incorporated by reference herein above, it is explicitly being incorporated herein in its entirety. All publications referenced herein above are incorporated herein by reference in their entireties.

What is claimed is:

1. An apparatus for providing at least one electromagnetic radiation, comprising:
at least one first arrangement which is configured to generate the at least one electromagnetic radiation having at least one wavelength that varies over time; and
at least one second arrangement which is configured to power the at least one first arrangement independently from an external power source.

2. The apparatus according to claim 1, wherein the at least one second arrangement is self contained with respect to providing power to the at least one first arrangement.

3. The apparatus according to claim 1, wherein the at least one wavelength varies over a range that is approximately greater than 80 nm.

4. The apparatus according to claim 3, wherein, at one particular point in time, the at least one electromagnetic radiation has a spectral width of approximately between 0.05 nm and 0.3 nm.

5. The apparatus according to claim 4, wherein a variation of the at least one wavelength is repetitive over a characteristic frequency of approximately greater than 15 kHz.

6. The apparatus according to claim 5, wherein the at least one first arrangement includes a resonant cavity that has a roundtrip optical transit time of approximately less than 0.7 nsec.

7. The apparatus according to claim 1, wherein the at least one wavelength varies at a rate of approximately greater than 100 THz per millisecond.

8. An apparatus for providing at least one electromagnetic radiation, comprising:
at least one particular arrangement which is configured to generate the at least one electromagnetic radiation having at least one wavelength that varies over time, wherein the at least one particular arrangement includes a resonant cavity that has a roundtrip optical transit time of approximately less than 0.7 nsec.

9. The apparatus according to claim 8, wherein the at least one wavelength varies over a range that is approximately greater than 80 nm.

10. The apparatus according to claim 9, wherein, at one particular point in time, the at least one electromagnetic radiation has a spectral width of approximately between 0.05 nm and 0.3 nm.

11. The apparatus according to claim 10, wherein a variation of the at least one wavelength is repetitive over a characteristic frequency of approximately greater than 15 kHz.

12. The apparatus according to claim 8, wherein the at least one wavelength varies over a range that is approximately greater than 80 nm.

13. The apparatus according to claim 8, further comprising at least one further arrangement which is configured to power the at least one particular arrangement independently from an external power source.

14. The apparatus according to claim 8, wherein the at least one wavelength varies at a rate of approximately greater than 100 THz per millisecond.
